(19) United States
(12) Patent Application Publication
(10) Pub. No.: US 2017/0287651 A1
(43) Pub. Date: Oct. 5, 2017

(54) CAPACITOR AND CAPACITOR MODULE

(71) Applicant: Komatsu Ltd., Tokyo (JP)

(72) Inventors: Koji Maeda, Tokyo (JP); Yutaka Itou, Tokyo (JP); Go Sakuma, Tokyo (JP); Takuji Okumura, Tokyo (JP); Akihiko Souda, Tokyo (JP); Takayoshi Endou, Tokyo (JP)

(21) Appl. No.: 15/124,503

(22) PCT Filed: Mar. 31, 2016
(86) PCT No.: PCT/JP2016/060723

§ 371 Date: Sep. 8, 2016

(51) Int. Cl. H01G 11/62; H01G 11/60; H01G 11/10

(52) U.S. Cl. CPC H01G 11/62; H01G 11/10; H01G 11/60

(57) ABSTRACT

An object of the present invention is to provide a capacitor and a capacitor module having a long life and capable of a stable action. Therefore, an electrolytic solution L obtained by dissolving an electrolyte salt having a lower hydrolyzability and a higher reaction potential in an electrode than an amidine salt containing a cation which is an imidazolium in a solvent and a sub solvent that reduces resistance of the electrolytic solution is packed in a cell. The electrolyte salt is a quaternary ammonium salt, the solvent is propylene carbonate, and the sub solvent is dimethyl carbonate. The quaternary ammonium salt is triethylmethylammonium tetrafluoroborate or azacyclobutane-1-spiro-1′-azacyclobutyl tetrafluoroborate. A pressure regulating valve 6 for regulating an inner pressure in the cell is disposed. A portion of the electrolytic solution L to be vaporized during use is packed in the cell as an excessive electrolytic solution in advance.

### Field

The present invention relates to a capacitor and a capacitor module each having a long life and capable of a stable action.

### BACKGROUND

An electric double layer capacitor has a structure in which an electrode element including a separator and a pair of polarizable electrodes disposed so as to face each other through the separator is sealed in a case, and the electrode element is impregnated with an electrolytic pole solution.

Here, Patent Literature 1 describes a capacitor including a pressure regulating valve for preventing pressure rise in a cell by releasing a gas generated in a cell to the outside when the pressure in the cell becomes a predetermined pressure or higher and maintaining a sealing property in the cell by returning after working to a state before working.

### CITATION LIST

### Patent Literature

Patent Literature 1: Japanese Laid-open Patent Publication No. 2009-194131

### SUMMARY

### Technical Problem

By the way, an electric double layer capacitor may use an imidazolium amidine salt (EDMI-BF4: 1-ethyl-2,3-dimethylimidazolium tetrafluoroborate) containing a cation and having a high alkalization suppressing effect in a negative electrode as an electrolyte salt of an electrolytic solution. However, EDMI-BF4 is easily deteriorated by a reaction (hydrolysis) between EDMI-BF4 and water in a cell. Therefore, there was a problem that an electrolytic solution using EDMI-BF4 had a short life.

In the electrolytic solution using EDMI-BF4, deterioration characteristics of capacitors have large variation. When deterioration characteristics of capacitors have large variation, a voltage equal to or higher than an allowable value is applied to a capacitor having a large deterioration characteristic among a plurality of capacitors connected in series, and it is difficult to secure a stable action.

The present invention has been achieved in view of the above, and an object thereof is to provide a capacitor and a capacitor module each having a long life and capable of a stable action.

### Solution to Problem

To solve the problem and achieve the object, a capacitor according to the present invention is characterized in that an electrolytic solution obtained by dissolving an electrolyte salt having a lower hydrolyzability and a higher reaction potential in an electrode than an amidine salt containing a cation which is an imidazolium in a solvent and a sub solvent that reduces resistance of the electrolytic solution is packed in a cell.

Moreover, in the capacitor according to the present invention, the electrolyte salt is a quaternary ammonium salt, the solvent is propylene carbonate, and the sub solvent is dimethyl carbonate.

Moreover, in the capacitor according to the present invention, the quaternary ammonium salt is triethylmethylammonium tetrafluoroborate.

Moreover, in the capacitor according to the present invention, the quaternary ammonium salt is a spiro quaternary ammonium salt.

Moreover, in the capacitor according to the present invention, the spiro quaternary ammonium salt is azacyclobutane-1-spiro-1′-azacyclobutyl tetrafluoroborate.

Moreover, in the capacitor according to the present invention includes: a pressure regulating mechanism configured to regulate an inner pressure of the cell.

Moreover, in the capacitor according to the present invention, a portion of an electrolytic solution to be vaporized during use is packed in the cell as an excessive electrolytic solution in advance.

Moreover, in the capacitor according to the present invention, the excessive electrolytic solution has such an amount that a distance between a liquid surface of the electrolytic solution and a sealing portion of the cell is a predetermined distance or more when a central axis of the cell is tilted by a predetermined angle with respect to a vertical axis.

Moreover, in the capacitor according to the present invention, the predetermined angle is a tilting angle allowable for a vehicle.

Moreover, a capacitor module according to the present invention is characterized in that a plurality of the capacitors according to one of the above-described invention are disposed to connect electrically to each other.

According to the present invention, an electrolytic solution obtained by dissolving an electrolyte salt having a lower hydrolyzability and a higher reaction potential in an electrode than an imidazolium amidine salt containing a cation in a sub solvent for reducing resistances of a solvent and an electrolytic solution is packed in a cell. Therefore, it is possible to realize a capacitor having a long life and capable of a stable action.

### BRIEF DESCRIPTION OF DRAWINGS

FIG. 1 is a cross sectional view illustrating a structure of a capacitor according to an embodiment of the present invention.

FIG. 2 is a cross sectional view of a main part, illustrating a sealing portion of the capacitor illustrated in FIG. 1.

FIG. 3 is a perspective view illustrating a state of an element used for the capacitor illustrated in FIG. 1 before current collectors are jointed to electrodes on both end surfaces of the element.

FIG. 4 is a view illustrating a plane and a front cross section illustrating a structure of an anode current collector jointed to an anode of the element.

FIG. 5 is a view illustrating a plane and a front cross section illustrating a structure of a cathode current collector jointed to a cathode of the element.

FIG. 6 is a view illustrating a plane and a front cross section illustrating a structure of an aluminum terminal plate to be jointed by stacking the terminal plate on the anode current collector.

FIG. 7 is a view illustrating a plane and a front cross section illustrating a structure of an annular sealing rubber formed of an insulating rubber for sealing an opening of a metal case.

FIG. 8 is a cross sectional view illustrating a structure of a pressure regulating valve connected so as to close an electrolytic solution injection hole in the terminal plate.

FIG. 9 is an exploded cross sectional view of the pressure regulating valve.

FIG. 10 is a diagram illustrating a relationship between deterioration of electrostatic capacitance and variation for a plurality of capacitors using TEMA-BF4, SBP-BF4, or EDMI-BF4 as an electrolytic solution at a temperature of 65° C. and a voltage of 2.8 V.

FIG. 11 is a diagram illustrating a relationship between deterioration of electrostatic capacitance and variation for a plurality of capacitors using TEMA-BF4, SBP-BF4, or EDMI-BF4 as an electrolytic solution at a temperature of 60° C. and a voltage of 2.6 V.

FIG. 12 is diagram illustrating temporal change in deterioration of an internal resistance for a plurality of capacitors using TEMA-BF4, SBP-BF4, or EDMI-BF4 as an electrolytic solution at a temperature of 60° C. and a voltage of 2.6 V.

FIG. 13 is diagram illustrating temporal change in deterioration of an internal resistance for a plurality of capacitors using TEMA-BF4, SBP-BF4, or EDMI-BF4 as an electrolytic solution at a temperature of 65° C. and a voltage of 2.8 V.

FIG. 14 is diagram illustrating temporal change in deterioration of an internal resistance for a plurality of capacitors using TEMA-BF4, SBP-BF4, or EDMI-BF4 as an electrolytic solution at a temperature of 65° C. and a voltage of 2.9 V.

FIG. 15 is diagram illustrating a withstand voltage property of a capacitor using TEMA-BF4, SBP-BF4, or EDMI-BF4 as an electrolytic solution.

FIG. 16 is diagram illustrating a distance between a liquid surface of an electrolytic solution and the sealing rubber at a maximum tilting angle 8 allowable for the capacitor.

### DESCRIPTION OF EMBODIMENTS

Hereinafter, an embodiment for performing the present invention will be described with reference to the attached drawings.

[Whole Structure of Capacitor]

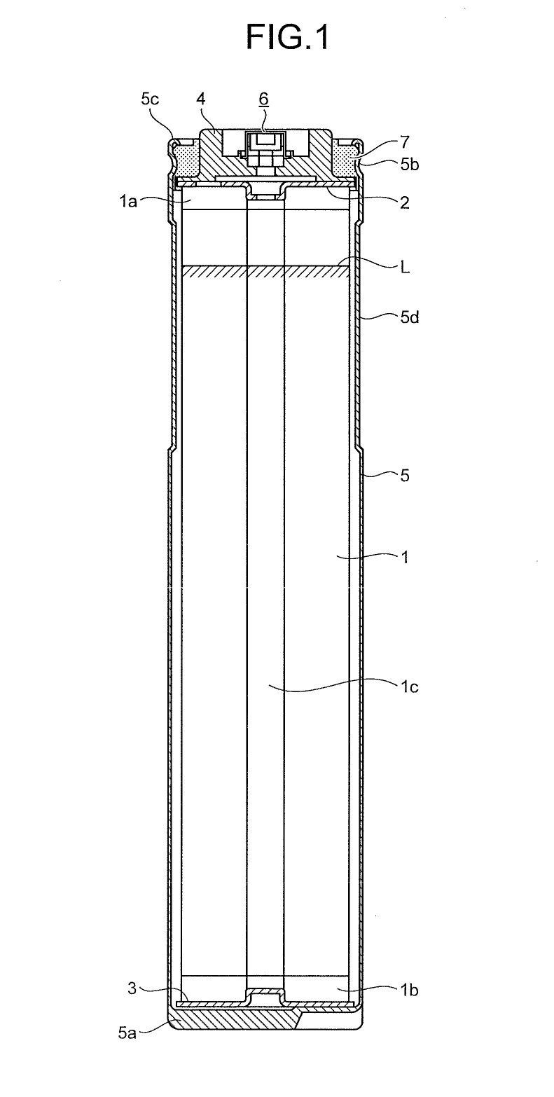

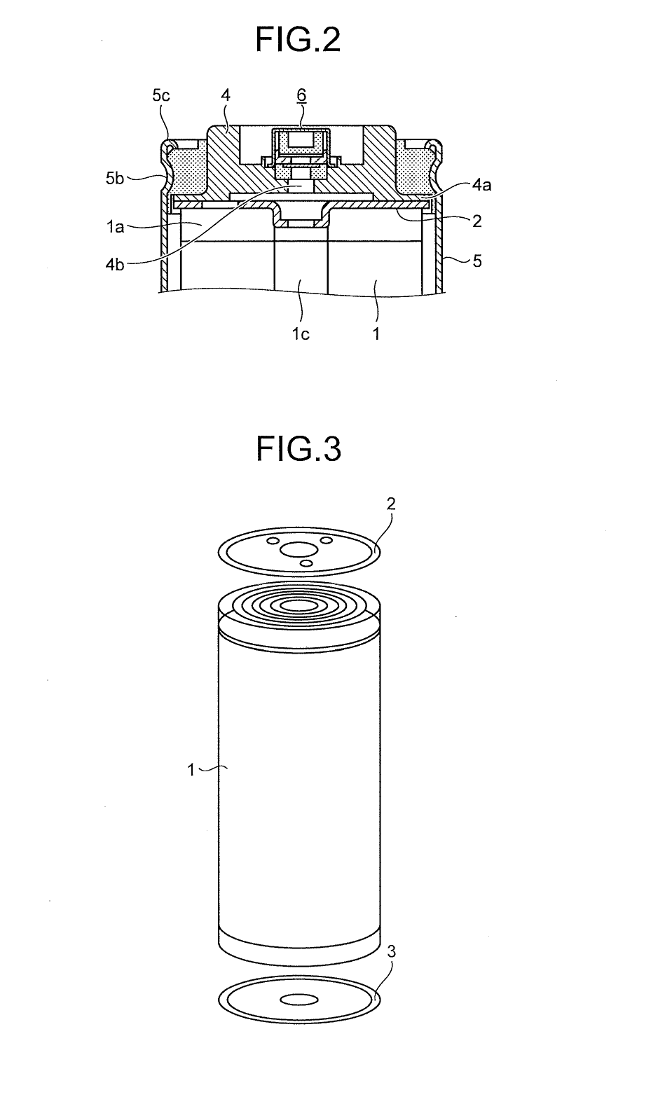

FIG. 1 is a cross sectional view illustrating a structure of a capacitor according to an embodiment of the present invention. FIG. 2 is a cross sectional view of a main part, illustrating a sealing portion of the capacitor illustrated in FIG. 1. FIG. 3 is a perspective view illustrating a state of an element used for the capacitor illustrated in FIG. 1 before current collectors are jointed to electrodes on both end surfaces of the element.

In FIGS. 1 to 3, a hollow portion lc is formed in an element 1. This element 1 is formed by shifting a pair of positive and cathodes obtained by forming a polarizable electrode 1a yer on an aluminum foil current collector in opposite directions to each other, interposing a separator therebetween, and winding the resulting product (none of these are illustrated). An anode 1a (upper side in FIG. 1) and a cathode 1b (lower side in FIG. 1) are extracted from both end surfaces (vertical direction in FIG. 1) of this element 1.

An anode current collector 2 is jointed to the anode 1a formed on one end surface of the element 1. A cathode current collector 3 is jointed to the cathode 1b formed on the other end surface of the element 1. The anode current collector 2 and the cathode current collector 3 are each formed by processing an aluminum plate, and are mechanically and electrically jointed to each other by performing laser welding while the anode current collector 2 and the cathode current collector 3 are stacked on the anode 1a of the element 1 and the cathode 1b thereof, respectively.

A terminal plate 4 includes a flange portion 4a disposed at a lower end of the terminal plate 4. By stacking this terminal plate 4 on the anode current collector 2 jointed to the anode 1a of the element 1 and performing laser welding from an upper surface side of the flange portion 4a disposed in the terminal plate 4, the flange portion 4a and a periphery of the anode current collector 2 are jointed to each other mechanically and electrically. The anode 1a of the element 1 is thereby extracted from the terminal plate 4.

A metal case 5 houses the anode current collector 2, the cathode current collector 3, and the element 1 to which the terminal plate 4 is jointed together with an electrolytic solution L, and is made of aluminum and has a bottomed cylindrical shape. A joint portion 5a is used for mechanical and electrical jointing by partially forming an inner bottom surface of the metal case 5 into a projection shape, inserting the element 1 into the metal case 5, then bringing the cathode current collector 3 jointed to the cathode 1b of the element 1 into a close contact with the joint portion 5a disposed in the metal case 5, and performing laser welding from a side of an outer bottom surface of the metal case 5. The cathode 1b of the element 1 is thereby extracted from the metal case 5.

A plane portion 5d formed by recessing a part of a peripheric surface of the metal case 5 on a side of the opening is used for making a connecting portion 5a easily subjected to laser welding by disposing the plane portion 5d in the metal case 5 when a plurality of the capacitors is connected to each other through a connecting member (not illustrated) to obtain a unit.

The pressure regulating valve 6 is connected so as to close an electrolytic solution injection hole 4b disposed in the terminal plate 4. A sealing rubber 7 is a sealing rubber formed of an insulating rubber. Sealing is performed by compressing the sealing rubber 7 by subjecting the vicinity of the opening of the metal case 5 to drawing (transverse groove drawing portion 5b) from an outer periphery while the sealing rubber 7 is disposed on an upper surface of the flange portion 4a disposed at a lower end of the terminal plate 4, and pressing an upper surface of the sealing rubber 7 by subjecting an opening end of the metal case 5 to curling (curling portion 5c).

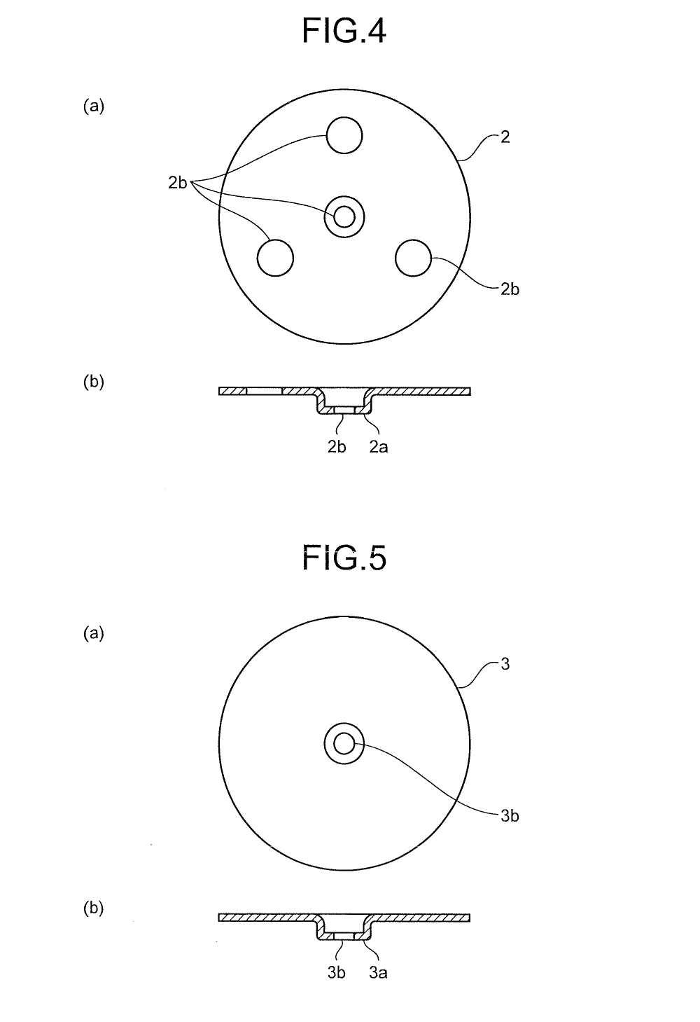

FIGS. 4(a) and 4(b) are views illustrating a plane and a front cross section illustrating a structure of the anode current collector 2 jointed to the anode 1a of the element 1. FIGS. 5(a) and 5(b) are views illustrating a plane and a front cross section illustrating a structure of the cathode current collector 3 jointed to the cathode lb of the element 1. In the anode current collector 2 and the cathode current collector 3, protrusions 2a and 3a fitted into the hollow portion lc disposed in the element 1 are formed, respectively. In the anode current collector 2 and the cathode current collector 3, electrolytic solution L-permeable holes 2b and 3b are formed, respectively. As for the electrolytic solution L-permeable holes 2b and 3b, a larger number of the holes 2b are disposed on the anode current collector 2 due to injection of the electrolytic solution L from a side of the anode current collector 2.

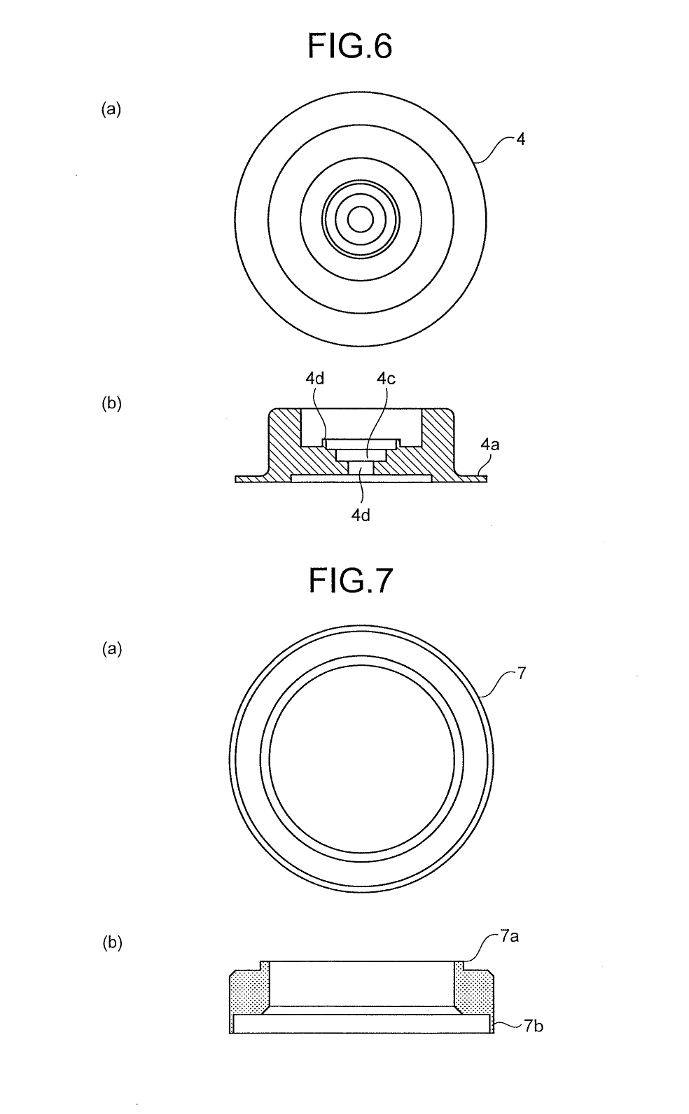

FIGS. 6(a) and 6(b) are views illustrating a plane and a front cross section illustrating a structure of the aluminum terminal plate 4 to be jointed by stacking the terminal plate 4 on the anode current collector 2. In FIG. 6, the flange portion 4a is disposed at a lower end of the terminal plate 4. A hole 4b is an electrolytic solution injection hole. A recess 4c is used for mounting the pressure regulating valve 6 thereon. A projection 4d is used for connecting the pressure regulating valve 6 by caulking.

FIGS. 7(a) and 7(b) are views illustrating a plane and a front cross section illustrating a structure of the annular sealing rubber 7 formed of an insulating rubber (a butyl rubber is used in the present embodiment, but the present invention is not limited thereto) for sealing the opening of the metal case 5. In FIG. 7, a wall portion 7a has an annular shape disposed so as to project into an upper end inner periphery. A wall portion 7b has an annular shape disposed so as to project into a lower end outer periphery. The upper wall portion 7a formed in this way is in close contact with an outer peripheric surface on an upper side of the terminal plate 4. The lower wall portion 7b is in close contact with a lower side of the terminal plate 4 and a gap between an outer peripheric surface of the anode current collector 2 and an inner peripheric surface of the metal case 5. Both of the upper wall portion 7a and the lower wall portion 7b are not necessarily required. Only one of these portions may be disposed on a portion necessary in terms of product design.

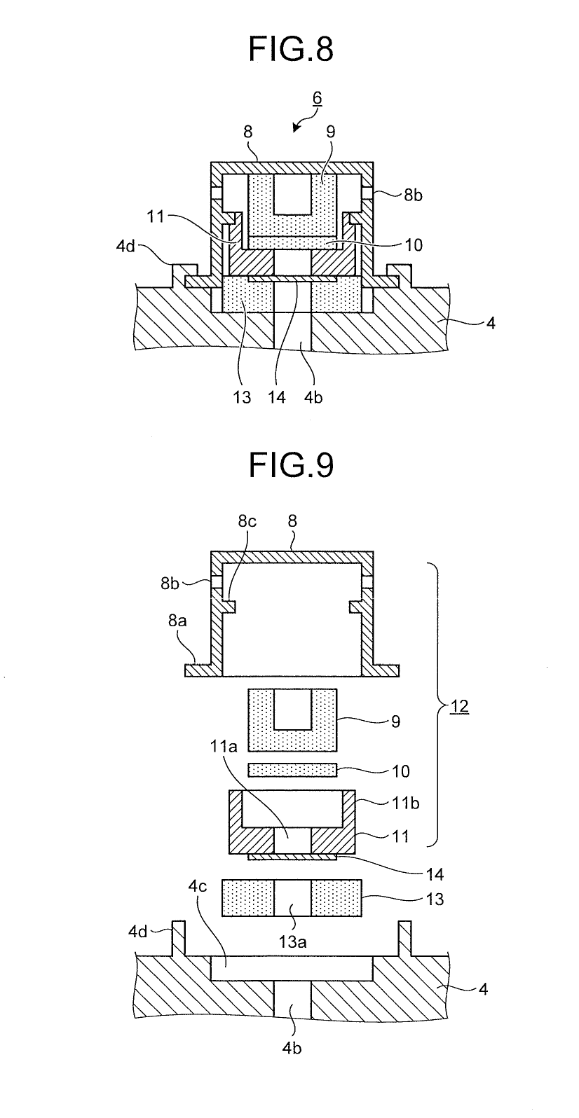

FIG. 8 is a cross sectional view illustrating a structure of the pressure regulating valve 6 connected so as to close the electrolytic solution injection hole 4b in the terminal plate 4. FIG. 9 is an exploded cross sectional view of the pressure regulating valve 6. In FIGS. 8 and 9, in a stainless steel cap 8 having a bottomed cylindrical shape, a flange portion 8a is disposed at an opening end, and a hole 8b communicating with an outside is disposed. A valve body 9 is made of a silicon rubber and has a bottomed cylindrical shape. A packing 10 is made of a butyl rubber. In an aluminum ring-shaped washer 11, a hole 11a is disposed in the center, and an annular wall portion 11b is disposed integrally in an upper surface periphery. By press-fitting the washer 11 in the cap 8 while the packing 10 and the valve body 9 are stacked on an inner bottom surface of the washer 11, the valve body 9 and the packing 10 are held in a compressed state, and a valve unit 12 is thereby formed.

In press-fitting of the washer 11 in the cap 8, control of a press-fitting size can be performed with high accuracy by using a jig (not illustrated). By disposing a cut-out section in a part of an inner peripheric surface of the cap 8 and disposing a cut and raised portion 8c processed such that the cut-out section projects into an inside of the cap 8, the cut and raised portion 8c disposed in the stainless steel cap 8 bites into the aluminum washer 11 when the washer 11 is press-fitted in the cap 8, and press-fitting to bring about a higher connecting strength can be performed.

A ring-shaped pressing rubber 13 is made of a butyl rubber and is provided with a hole 13a in the center. The valve unit 12 is disposed while the pressing rubber 13 is disposed in the recess 4c disposed in an upper portion of the electrolytic solution injection hole 4b disposed in the terminal plate 4. The projection 4d disposed in the terminal plate 4 is subjected caulking processing, is thereby brought into pressure contact with the flange portion 8a disposed in the opening end of the cap 8, and is mechanically connected to the flange portion 8a. The pressing rubber 13 can be thereby held in a compressed state.

A gas-permeable sheet 14 is made of a porous film formed of polytetrafluoroethylene (PTFE). An example in which the gas-permeable sheet 14 is jointed by thermally fusing the gas-permeable sheet 14 to a bottom surface of the ring-shaped washer 11 constituting the valve unit 12 using modified PP is illustrated. However, the gas-permeable sheet 14 may be jointed to an upper surface of the electrolytic solution injection hole 4b disposed in the terminal plate 4 after injection of an electrolytic solution by a similar method.

When the pressure in the capacitor rises to a predetermined pressure or higher, the pressure regulating valve 6 having such a structure prevents permeation of the electrolytic solution L due to the gas-permeable sheet 14 and allows only a gas to permeate therethrough. Therefore, the gas having a pressure which has risen pushes up the packing 10 and the valve body 9, goes from an interface between the packing 10 and the washer 11 to an inside of the cap 8, and is released to the outside through the hole 8b disposed in the cap 8. The pressure regulating valve 6 is a self-reset type valve which can maintain a sealing property in the capacitor by returning after working in this way to a state before working. This can improve assembling accuracy as the valve unit 12 largely. Therefore, not only working variation as the pressure regulating valve 6 can be reduced and stable performance can be exhibited, but also working confirmation as the pressure regulating valve 6 can be performed only by the valve unit 12.

Furthermore, the pressure regulating valve 6 has a structure in which the valve body 9 is made of a silicon rubber and the valve body 9 is stacked on the butyl rubber packing 10, and thereby has excellent heat resistance.

[Electrolytic Solution]

The electrolytic solution L is obtained by dissolving an electrolyte salt having a lower hydrolyzability and a higher reaction potential in an electrode than an imidazolium amidine salt containing a cation, such as EDMI-BF4, in a sub solvent for reducing resistances of a solvent and an electrolytic solution, and is packed in a cell formed by the metal case 5 and the terminal plate 4. The electrolytic solution L is packed in the cell such that a separator is impregnated with the electrolytic solution L. In addition, a portion of the electrolytic solution L to be vaporized during use is packed in the cell as an excessive electrolytic solution in advance. Therefore, in the electrolytic solution L, a liquid surface is formed perpendicularly to the vertical direction.

For example, the electrolyte salt of the electrolytic solution L is a quaternary ammonium salt, the solvent is propylene carbonate (PC), and the sub solvent is dimethyl carbonate (DMC). Examples of the quaternary ammonium salt include triethylmethylammonium-tetrafluoroborate (TEMA-BF4). The quaternary ammonium salt is a Spiro quaternary ammonium salt, and examples thereof include azacyclobutane-1-spiro-1′-azacyclobutyl tetrafluoroborate (SBP-BF4).

The electrolytic solution L containing TEMA-BF4 as an electrolyte salt (hereinafter, referred to as TEMA-BF4) has a solvent ratio (solvent/sub solvent) of 70/30 and an electrolyte salt concentration of 1.5 (mol/L). The electrolytic solution L containing SBP-BF4 as an electrolyte salt (hereinafter, referred to as SBP-BF4) has a solvent ratio (solvent/sub solvent) of 70/30 and an electrolyte salt concentration of 1.5 (mol/L).

The sub solvent DMC reduces an internal resistance. This reduces generation of heat during charge-discharge, and makes use of a high voltage possible consequently. However, in a cell not provided with the pressure regulating valve 6, the sub solvent DMC is vaporized easily, and therefore a vapor pressure in the cell is high and a withstand voltage can be thereby high. However, in the present embodiment, the pressure regulating valve 6 is disposed, and therefore pressure rise in the cell can be suppressed. Even when the electrolytic solution L is released to the outside through the pressure regulating valve 6, a portion of the electrolytic solution L to be vaporized and released to the outside during use is packed in surplus in the cell as an excessive electrolytic solution in advance. Therefore, capacitor performance such as electrostatic capacitance is not deteriorated.

The above quaternary ammonium salt is not limited to triethylmethylammonium-tetrafluoroborate. Examples thereof include tetramethylammonium tetrafluoroborate, ethyltrimethylammonium tetrafluoroborate, diethyldimethylammonium tetrafluoroborate, triethylmethylammonium tetrafluoroborate, tetraethylammonium tetrafluoroborate, trimethyl-n-propylammonium tetrafluoroborate, trimethylisopropylammonium tetrafluoroborate, ethyldimethyl-n-propylammonium tetrafluoroborate, ethyldimethylisopropylammonium tetrafluoroborate, diethylmethyl-n-propylammonium tetrafluoroborate, diethylmethylisopropylammonium tetrafluoroborate, dimethyldi-n-propylammonium tetrafluoroborate, dimethyl-n-propylisopropylammonium tetrafluoroborate, dimethyldiisopropylammonium tetrafluoroborate, triethyl-n-propylammonium tetrafluoroborate, n-butyltrimethylammonium tetrafluoroborate, isobutyltrimethylammonium tetrafluoroborate, t-butyltrimethylammonium tetrafluoroborate, triethylisopropylammonium tetrafluoroborate, ethylmethyldi-n-propylammonium tetrafluoroborate, ethylmethyl-n-propylisopropylammonium tetrafluoroborate, ethylmethyldiisopropylammonium tetrafluoroborate, n-butylethyldimethylammonium tetrafluoroborate, isobutylethyldimethylammonium tetrafluoroborate, t-butylethyldimethylammonium tetrafluoroborate, diethyldi-n-propylammonium tetrafluoroborate, diethyl-n-propylisopropylammonium tetrafluoroborate, diethyldiisopropylammonium tetrafluoroborate, methyltri-n-propylammonium tetrafluoroborate, methyldi-n-propylisopropylammonium tetrafluoroborate, methyl-n-propyldiisopropylammonium tetrafluoroborate, n-butyltriethylammonium tetrafluoroborate, isobutyltriethylammonium tetrafluoroborate, t-butyltriethylammonium tetrafluoroborate, di-n-butyldimethylammonium tetrafluoroborate, diisobutyldimethylammonium tetrafluoroborate, di-t-butyldimethylammonium-tetrafluoroborate, n-butylisobutyldimethylammonium tetrafluoroborate, and n-butyl-t-butyldimethylammonium tetrafluoroborate.

The above Spiro quaternary ammonium salt is not limited to azacyclobutane-1-Spiro-1′-azacyclobutyl tetrafluoroborate. Examples thereof include pyrrolidine-1-spiro-1′-azacyclobutyl tetrafluoroborate, spiro-[1,1′]-bipyrrolidinium tetrafluoroborate, piperidine-1-spiro-1′-pyrrolidinium tetrafluoroborate, spiro-[1,1′]-bipiperidinium tetrafluoroborate, 3-ethylpyrrolidinium-1-spiro-1′-pyrrolidinium tetrafluoroborate, 3-ethylpyrrolidinium-1-spiro-1′-[3′-ethyl]pyrrolidinium tetrafluoroborate, 2,4-difluoropyrrolidinium-1-spiro-1′-pyrrolidinium tetrafluoroborate, and 2,4-difluoropyrrolidinium-1-spiro-1′-[2′,4′-difluoro]pyrrolidinium tetrafluoroborate.

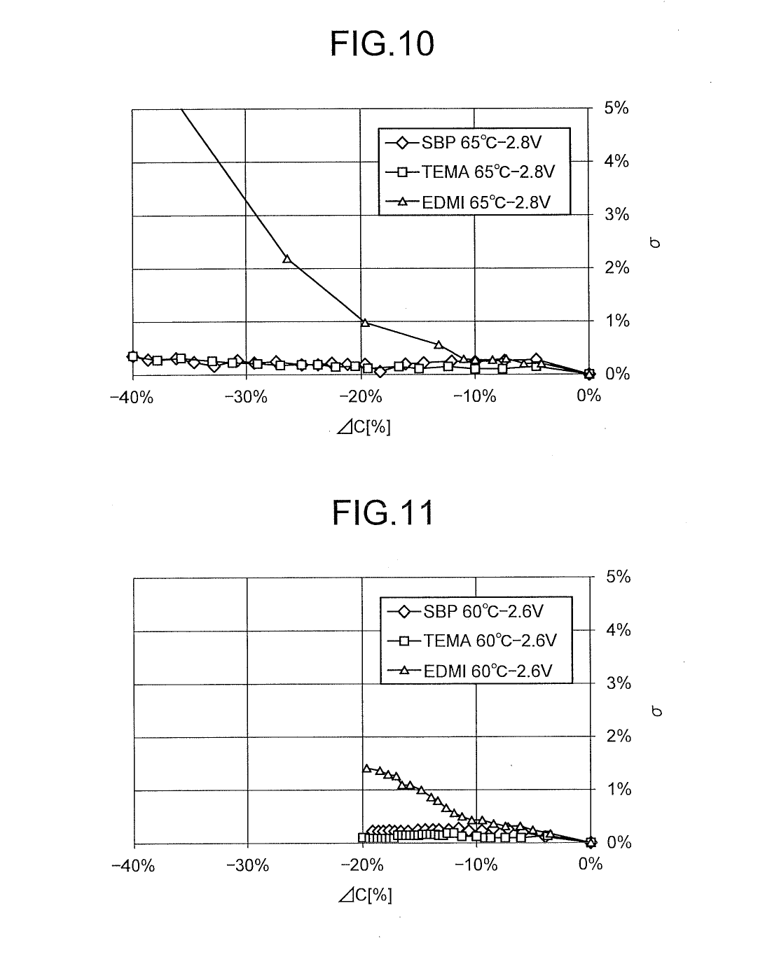

FIGS. 10 and 11 are diagrams illustrating a relationship between deterioration AC of electrostatic capacitance and variation (standard deviation) n for a plurality of capacitors using TEMA-BF4, SBP-BF4, or EDMI-BF4 as the electrolytic solution L. Environment conditions in FIG. 10 are a temperature of 65° C. and a voltage of 2.8 V. Environment conditions in FIG. 11 are a temperature of 60° C. and a voltage of 2.6 V. EDMI-BF4 as the conventional electrolytic solution L has a solvent ratio (solvent (PC)/sub solvent (DMC)) of 70/30 and an electrolyte salt concentration of 1.0 (mol/L).

As illustrated in FIGS. 10 and 11, TEMA-BF4 and SBP-BF4 each have a flatter variation c than EDMI-BF4 with respect to the deterioration AC of electrostatic capacitance. This is because TEMA-BF4 and SBP-BF4 each have a lower hydrolyzability than EDMI-BF4, and are hardly deteriorated by a reaction with water contained in the cell. In addition, this is because TEMA-BF4 and SBP-BF4 are hardly deteriorated due to a high reaction potential in an electrode, As a result, it can be said that TEMA-BF4 and SBP-BF4 have higher stability than EDMI-BF4.

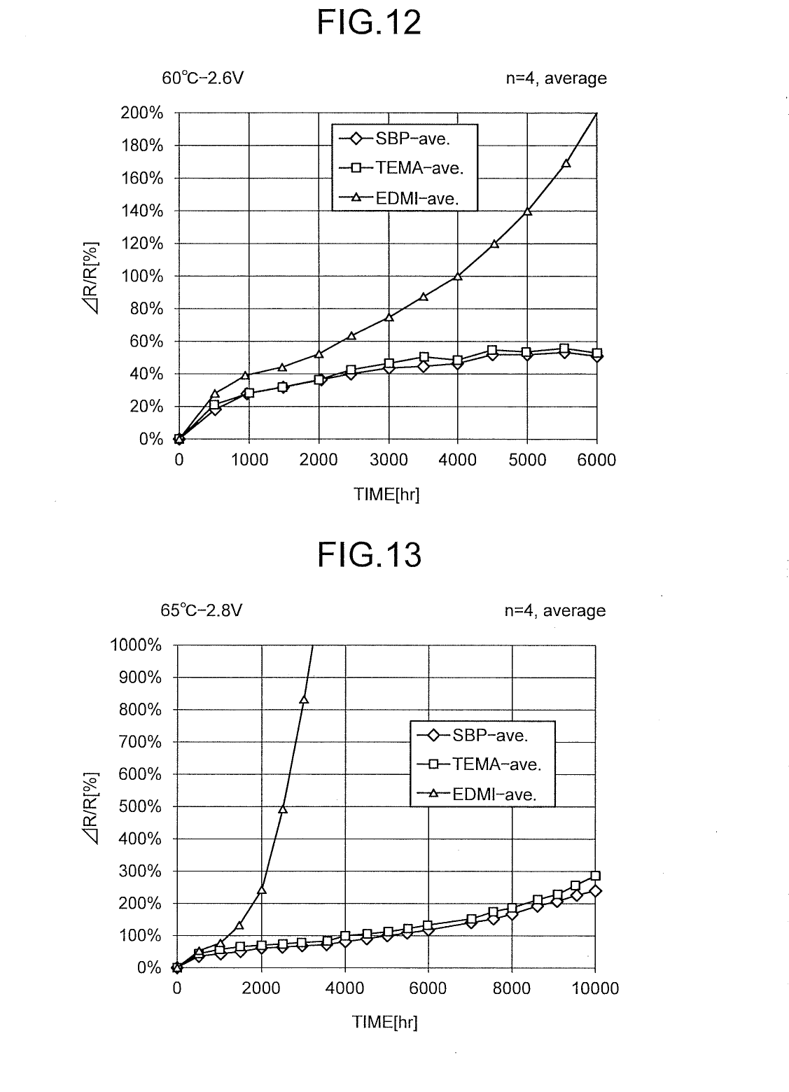

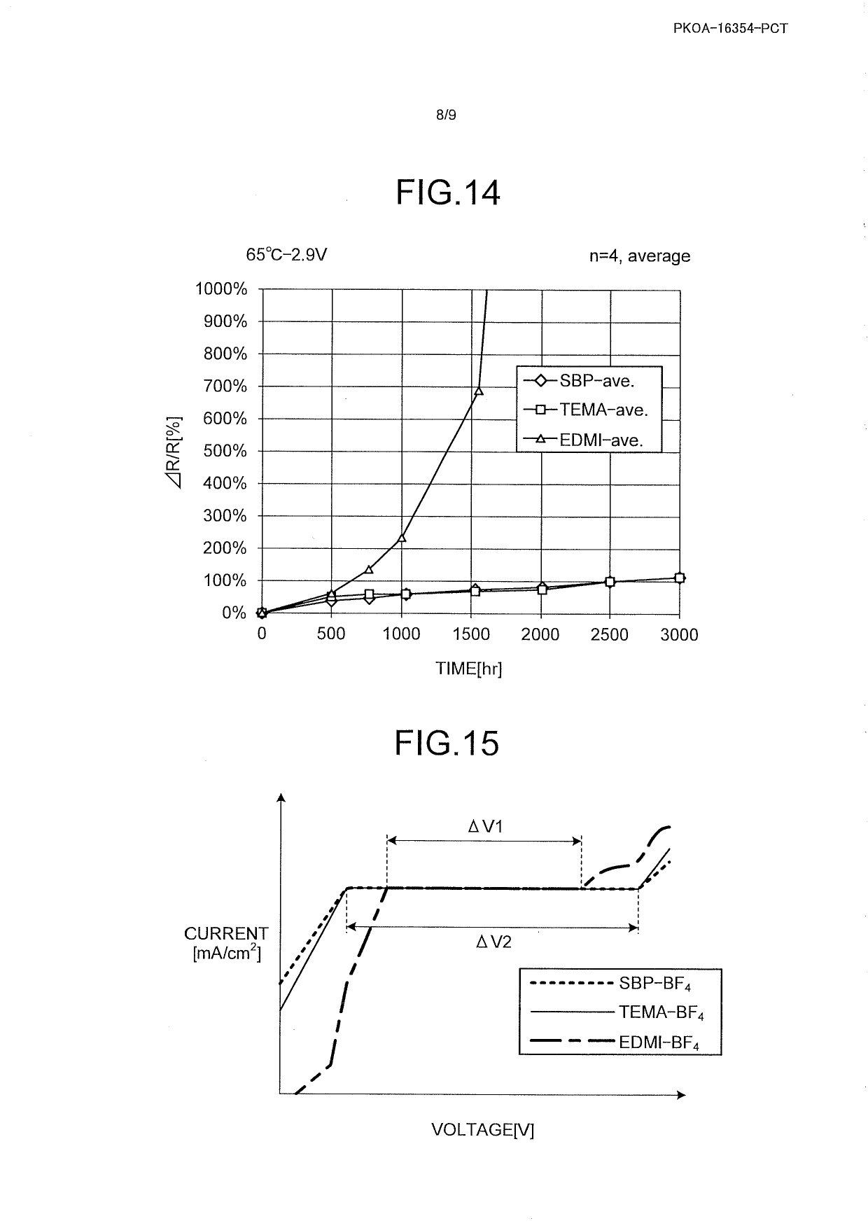

FIGS. 12 to 14 are diagrams illustrating temporal change in deterioration (AR/R) of an internal resistance for a plurality of capacitors using TEMA-BF4, SBP-BF4, or EDMI-BF4 as the electrolytic solution L. Environment conditions in FIG. 12 are a temperature of 60° C. and a voltage of 2.6 V. Environment conditions in FIG. 13 are a temperature of 65° C. and a voltage of 2.8 V. Environment conditions in FIG. 14 are a temperature of 65° C. and a voltage of 2.9 V.

As illustrated in FIGS. 12 to 14, TEMA-BF4 and SBP-BF4 have slower temporal change in deterioration (AR/R) of an internal resistance than EDMI-BF4. That is, it can be said that TEMA-BF4 and SBP-BF4 each have a longer life than EDMI-BF4. This is because TEMA-BF4 and SBP-BF4 each have a lower hydrolyzability than EDMI-BF4, and are hardly deteriorated by a reaction with water contained in the cell. In addition, this is because TEMA-BF4 and SBP-BF4 are hardly deteriorated due to a high reaction potential in an electrode,

FIG. 15 is diagram illustrating a withstand voltage property of a capacitor using TEMA-BF4, SBP-BF4, or EDMI-BF4 as the electrolytic solution L. As illustrated in FIG. 15, a voltage stability width ΔV2 of each of TEMA-BF4 and SBP-BF4 is wider than a voltage stability width ΔV1 of EDMI-BF4. TEMA-BF4 and SBP-BF4 have higher withstand voltage performance (higher reaction potential in an electrode) than EDMI-BF4.

Here, TEMA-BF4 and SBP-BF4 each have a lower alkalization suppressing effect in a negative electrode than EDMI-BF4. Therefore, by contact between the electrolytic solution L and the sealing rubber 7 for sealing a gap between the metal case 5 and the terminal plate 4, the sealing rubber 7 is deteriorated. Deterioration of the sealing rubber 7 leads to liquid leakage, causing unusability.

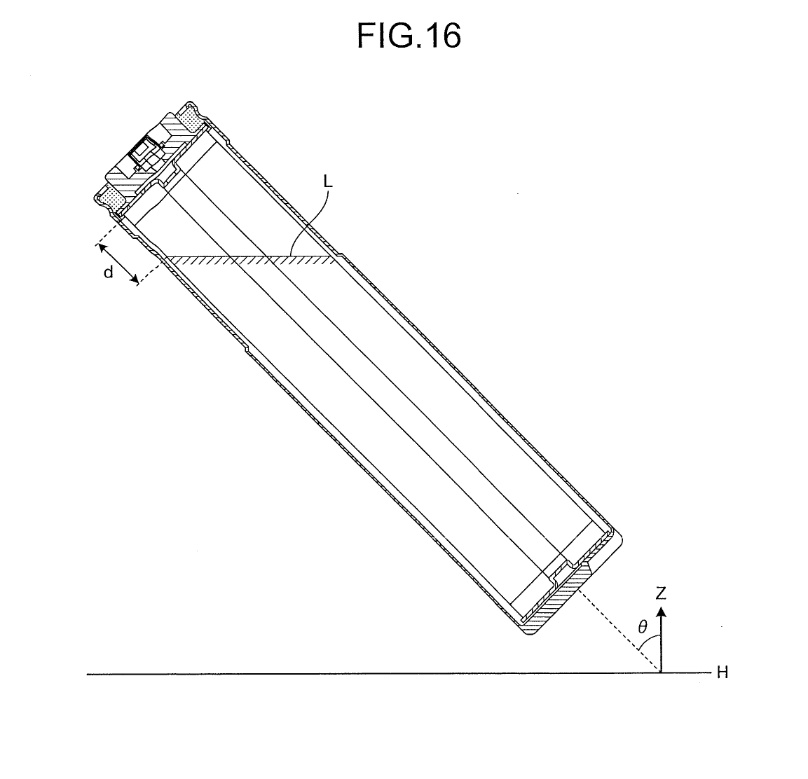

Therefore, as illustrated in FIG. 16, the electrolytic solution L is packed in the cell such that a distance between a liquid surface of the electrolytic solution L and the sealing rubber 7 is d or more at a maximum tilting angle θ allowable for the capacitor. This prevents contact between the electrolytic solution L and the sealing rubber 7, and therefore can suppress deterioration of the sealing rubber 7 and can set a capacitor voltage high. The maximum tilting angle θ is an angle with respect to a vertical axis Z perpendicular to a horizontal surface H. The distance d can be determined arbitrarily considering a vibration environment of a vehicle on which the capacitor is mounted or the like, a gap size between the element 1 and the metal case 5, and the like. For example, the capacitor of the present embodiment is disposed in an upper swing body of a hybrid type construction machine.

By the packing amount of the electrolytic solution L illustrated in FIG. 16, high withstand voltage performance can be obtained even with TEMA-BF4 or SBP-BF4 having a low alkalizatibn suppressing effect. Particularly when the capacitor is mounted on a vehicle such as a construction machine, the maximum tilting angle θ is preferably a maximum tilting angle allowable for the vehicle.

TEMA-BF4 and SBP-BF4 each have a small variation a in deterioration ΔC. Therefore, when a capacitor module obtained by disposing a plurality of capacitors in parallel and connecting the capacitors electrically in series is used, many capacitors do not have a large deterioration characteristic among the capacitors constituting the capacitor module. Therefore, a whole capacitor voltage can be obtained stably.

The above capacitor is suitable for regeneration of various electronic devices or a hybrid vehicle, electric power storage, and the like.

### REFERENCE SIGNS LIST

1 ELEMENT

1a ANODE

1b CATHODE

1c HOLLOW PORTION

2 ANODE CURRENT COLLECTOR

2a, 3a PROTRUSION

2b, 3b, 4b, 8b, 11a, 13a HOLE

3 CATHODE CURRENT COLLECTOR

4a, 8a FLANGE PORTION

4c RECESS

4d PROJECTION

METAL CASE

5a JOINT PORTION

5b TRANSVERSE GROOVE DRAWING PORTION

5c CURLING PORTION

5d PLANE PORTION

6 PRESSURE REGULATING VALVE

7 SEALING RUBBER

7a, 7b, 11b WALL PORTION

8 CAP

8c CUT AND RAISED PORTION

9 VALVE BODY

10 PACKING

11 WASHER

12 VALVE UNIT

13 PRESSING RUBBER

14 GAS-PERMEABLE SHEET

L ELECTROLYTIC SOLUTION

1-10.(canceled)

11. A capacitor comprising:
a cell; and
an electrolytic solution packed in the cell, and obtained by dissolving, in a solvent and a sub solvent that reduces resistance of the electrolytic solution, an electrolyte salt having a lower hydrolyzability and a higher reaction potential in an electrode than an amidine salt containing a cation which is an imidazolium.

12. The capacitor according to claim 11, wherein the electrolyte salt is a quaternary ammonium salt, the solvent is propylene carbonate, and the sub solvent is dimethyl carbonate.

13. The capacitor according to claim 12, wherein the quaternary ammonium salt is triethylmethylammonium tetrafluoroborate.

14. The capacitor according to claim 12, wherein the quaternary ammonium salt is a spiro quaternary ammonium salt.

15. The capacitor according to claim 14, wherein the spiro quaternary ammonium salt is azacyclobutane-1-spiro-1′-azacyclobutyl tetrafluoroborate.

16. The capacitor according to claim 11, comprising a pressure regulating mechanism configured to regulate an inner pressure of the cell.

17. The capacitor according to claim 11, wherein a portion of an electrolytic solution to be vaporized during use is packed in the cell as an excessive electrolytic solution in advance.

18. The capacitor according to claim 17, wherein the excessive electrolytic solution has such an amount that a distance between a liquid surface of the electrolytic solution and a sealing portion of the cell is a predetermined distance or more when a central axis of the cell is tilted by a predetermined angle with respect to a vertical axis.

19. The capacitor according to claim 18, wherein the predetermined angle is a tilting angle allowable for a vehicle.

20. The capacitor according to claim 12, comprising a pressure regulating mechanism configured to regulate an inner pressure of the cell.

21. The capacitor according to claim 13, comprising a pressure regulating mechanism configured to regulate an inner pressure of the cell.

22. The capacitor according to claim 14, comprising a pressure regulating mechanism configured to regulate an inner pressure of the cell.

23. The capacitor according to claim 15, comprising a pressure regulating mechanism configured to regulate an inner pressure of the cell.

24. The capacitor according to claim 12, wherein a portion of an electrolytic solution to be vaporized during use is packed in the cell as an excessive electrolytic solution in advance.

25. The capacitor according to claim 13, wherein a portion of an electrolytic solution to be vaporized during use is packed in the cell as an excessive electrolytic solution in advance.

26. The capacitor according to claim 14, wherein a portion of an electrolytic solution to be vaporized during use is packed in the cell as an excessive electrolytic solution in advance.

27. The capacitor according to claim 15, wherein a portion of an electrolytic solution to be vaporized during use is packed in the cell as an excessive electrolytic solution in advance.

28. The capacitor according to claim 16, wherein a portion of an electrolytic solution to be vaporized during use is packed in the cell as an excessive electrolytic solution in advance.

29. A capacitor module comprising:
a plurality of capacitors disposed and connected electrically to each other, each of the capacitors comprising;
a cell; and
an electrolytic solution packed in the cell, and obtained by dissolving, in a solvent and a sub solvent that reduces resistance of the electrolytic solution, an electrolyte salt having a lower hydrolyzability and a higher reaction potential in an electrode than an amidine salt containing a cation which is an imidazolium.
